(19) United States
(12) Patent Application Publication
(10) Pub. No.: US 2020/0394844 A1
(43) Pub. Date: Dec. 17, 2020

(54) DISPLAY METHOD, IMAGE GENERATION DEVICE, AND COMPUTER-READABLE NON-TRANSITORY RECORDING MEDIUM ON WHICH PROGRAM IS RECORDED

(71) Applicant: Panasonic Intellectual Property Management Co., Ltd., Osaka (JP)

(72) Inventor: SHINICHI KOSHIBA, Osaka (JP)

(21) Appl. No.: 16/893,061

(22) Filed: Jun. 4, 2020

(30) Foreign Application Priority Data
Jun. 14, 2019 (JP) 2019-110846

(51) Int. Cl. G06T 19/00; G06T 7/90; G06T 7/50; G06T 17/10

(52) U.S. Cl. CPC G06T 19/006; G06T 7/90; G06T 2200/24; G06T 17/10; G06T 2207/10028; G06T 7/50

(57) ABSTRACT

Provided is a display method for superimposing and displaying a second object on a virtual space including a first object which is formed of point cloud data acquired from a real space, the method includes: determining a movable region of the second object; generating the third object corresponding to the movable region of the second object; and outputting information for superimposing and displaying the third object on the virtual space.

### BACKGROUND

### 1. Technical Field

The present disclosure relates to a display method, an image generation device, and a non-transitory computer-readable recording medium on which a program is recorded.

### 2. Description of the Related Art

In the related art, when new equipment is installed in a factory or the like, the interference between the new equipment and existing equipment may be checked by simulation. Japanese Patent Unexamined Publication No. 2002-230057 discloses a three-dimensional model simulator that acquires a three-dimensional image of a real object that changes a shape (new equipment) in a time-series manner and determines whether or not interference occurs using the acquired time-series three-dimensional image.

### SUMMARY

According to an aspect of the present disclosure, there is provided a display method for superimposing and displaying a second object on a virtual space including a first object which is formed of first point cloud data acquired from a real space, the method including: determining a movable region of the second object; generating a third object corresponding to the movable region; and outputting information for superimposing and displaying the third object on the virtual space.

According to another aspect of the present disclosure, there is provided an image generation device for generating an image of a virtual space obtained by superimposing a second object on the virtual space including a first object which is formed of point cloud data acquired from a real space, the device including: a circuit; and a memory, in which the circuit is configured to, by using the memory, determine a movable region of the second object, generate a third object corresponding to the movable region, and output the image for superimposing and displaying the third object on the virtual space.

### BRIEF DESCRIPTION OF THE DRAWINGS

FIG. 1 is a block diagram showing a functional configuration of a display system according to Exemplary Embodiment 1;

FIG. 2 is a diagram showing an example of point cloud data according to Exemplary Embodiment 1;

FIG. 3 is a diagram showing an example of traffic line information according to Exemplary Embodiment 1;

FIG. 4 is a sequence diagram showing an operation of the display system according to Exemplary Embodiment 1;

FIG. 5 is a diagram in which a second object is superimposed on a virtual space according to Exemplary Embodiment 1;

FIG. 6 is a diagram in which a third object is superimposed on the virtual space shown in FIG. 5;

FIG. 7 is a diagram showing an example of sweeping of point cloud data;

FIG. 8 is a flowchart showing an operation of the image generation device according to Exemplary Embodiment 1;

FIG. 9 is a flowchart for explaining an operation of the image generation device according to a modification example of Exemplary Embodiment 1;

FIG. 10 is a diagram showing an example of a display image according to a modification example of Exemplary Embodiment 1;

FIG. 11 is a flowchart showing an operation of the image generation device according to Exemplary Embodiment 2;

FIG. 12 is a diagram in which a second object is superimposed on a virtual space according to Exemplary Embodiment 2; and

FIG. 13 is a diagram in which a third object is superimposed on the virtual space shown in FIG. 12.

### DETAILED DESCRIPTIONS

In the related art, in order to determine whether or not interference occurs, it is necessary to actually move a device (for example, by changing the shape of the device) and capture an image of a movable region of the device, which was troublesome.

Therefore, the present disclosure provides a display method capable of performing a display for checking whether or not interference occurs without moving an actual device.

Hereinafter, exemplary embodiments will be described with reference to the drawings. Each of the exemplary embodiments described below shows a comprehensive or specific example. Numerical values, shapes, materials, constituent elements, arrangement positions and connection forms of the constituent elements, steps, order of steps, and the like shown in the following exemplary embodiments are merely examples, and do not limit the present disclosure. Further, among the constituent elements in the following exemplary embodiments, constituent elements not described in the independent claims are described as any components.

Each diagram is a schematic diagram and is not necessarily shown exactly. In each of the diagrams, substantially the same components are denoted by the same reference numerals, and redundant description may be omitted or simplified.

### Exemplary Embodiment 1

### 1. Configuration of Display System

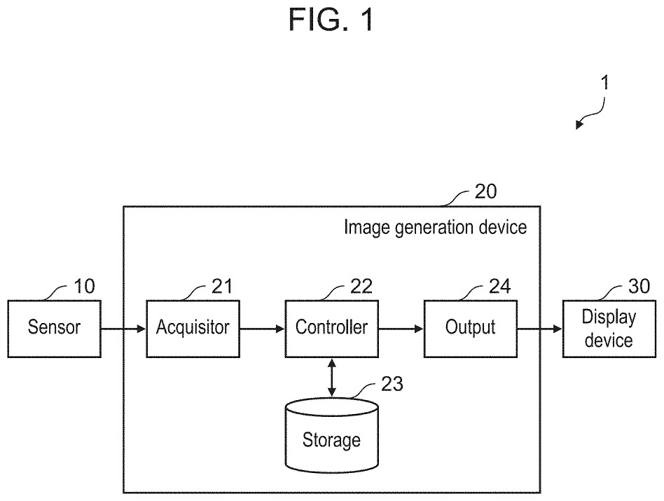

First, a configuration of a display system according to the exemplary embodiment will be described with reference to FIG. 1. FIG. 1 is a block diagram showing a functional configuration of display system 1 according to the present exemplary embodiment.

As shown in FIG. 1, display system 1 includes sensor 10, image generation device 20, and display device 30. Display system 1 is a system for superimposing and displaying a second object on a virtual space including a first object formed of point cloud data acquired from a real space. Specifically, display system 1 is a system that generates and displays an image for determining whether or not the second object interferes with the first object.

Display system 1 is used, for example, to check whether or not interference occurs between the equipment in a layout after the change when the layout inside the factory is changed. Hereinafter, an example in which display system 1 is used for checking interference between new equipment and existing equipment will be described when the new equipment is installed at the factory, but an application example is not limited to this.

In this case, the first object is the existing equipment (or an object corresponding to the existing equipment), and the second object is the new equipment (or an object corresponding to the new equipment). The existing equipment is, for example, a device, a pipe, or the like that constitutes the current factory. The new equipment is, for example, a device that is newly installed in the factory. Hereinafter, an example in which the new equipment is a hairpin bending device that performs a bending process in a U-shape on a pipe will be described. The real space is, for example, an internal space of the factory.

Sensor 10 is a device that performs measurement for generating a virtual space (for example, a simulation space) including the first object formed of point cloud data acquired from the real space. Sensor 10 is realized by a 3D scanner (for example, a 3D laser scanner).

Sensor 10 performs a three-dimensional scan (for example, a three-dimensional laser scan) on a target (here, inside the real factory), and acquires the point cloud data indicating a three-dimensional shape of the surface of the target. Sensor 10 outputs the acquired point cloud data to image generation device 20.

Sensor 10 measures, for example, from a plurality of portions different from each other, and outputs the point cloud data acquired at each portion to image generation device 20. Although the example in which the number of sensors 10 included in display system 1 is one has been described, the number may be two or more.

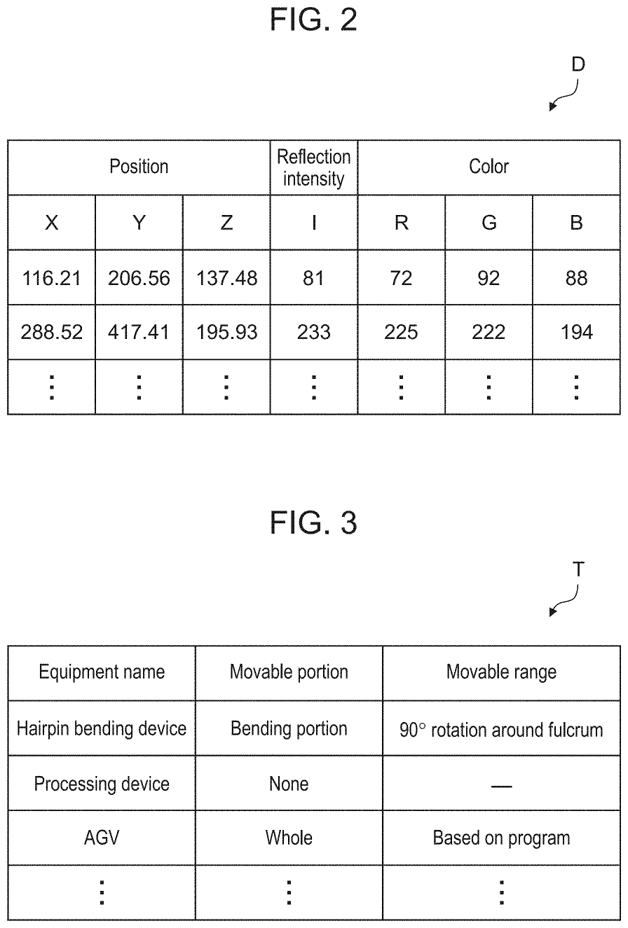

For example, as shown in FIG. 2, the point cloud data includes information about a position (x, y, z) of each point, reflection intensity (I) at the position, and color (R, G, B) at the position. FIG. 2 is a diagram showing an example of point cloud data D. Point cloud data D only needs to include only the position among the position, the reflection intensity, and the color. Point cloud data D is an example of first point cloud data.

Image generation device 20 is a processing device that performs a process of generating an image for determining whether or not the new equipment interferes with the existing equipment based on the three-dimensional information of the new equipment and point cloud data D acquired from sensor 10 and outputting the image. Image generation device 20 includes acquisitor 21, controller 22, storage 23, and output 24. Image generation device 20 is an example of an image generation device.

Acquisitor 21 is communicably connected to sensor 10 and acquires point cloud data D from sensor 10. Acquisitor 21 is, for example, a wireless communication module or a wireless communication circuit, and acquires point cloud data D from sensor 10 by wireless communication. The communication standard of the wireless communication is not particularly limited. The wireless communication is radio wave communication, but may be optical communication or the like.

Controller 22 generates a virtual space including the first object based on the plurality of portions of point cloud data D acquired from sensor 10. Controller 22 stores the generated information about the virtual space in storage 23. Controller 22 specifies a swept region by sweeping the movable portion over the movable region in the virtual space based on the three-dimensional information about new equipment newly installed in the factory and information indicating the movable region of the movable portion of the new equipment (hereinafter, it is also referred to as traffic line information), and generates a third object corresponding to the swept region. The three-dimensional information (three-dimensional data) of the new equipment is data indicating a three-dimensional shape when the new equipment is in a stationary state. The three-dimensional information may be, for example, data based on CAD data or data based on point cloud data obtained by measuring the new equipment in a stationary state by sensor 10. Specifically, the three-dimensional information is solid data in which CAD data or point cloud data of new equipment is converted, surface data, or polygon data. The three-dimensional information may be point cloud data obtained by measuring the new equipment in a stationary state by sensor 10. The stationary state means a state in which the movable portion of the new equipment is not movable, for example, a state in which the movable portion is disposed at an initial position. Further, in the present exemplary embodiment, the third object is an object corresponding to the movable region of a bending portion that is movable portion mp of the hairpin bending device.

Controller 22 controls to output information for checking interference with the existing equipment when the new equipment is disposed to display device 30 via output 24. Specifically, controller 22 controls to output information for superimposing and displaying the third object on the virtual space to display device 30 via output 24. Controller 22 may output information about the virtual space and the third object directly to display device 30 or may output the information to a server device (not shown) that collects the information.

Controller 22 is specifically a microcomputer, but may be realized by a processor or a dedicated circuit. Controller 22 may be realized by a combination of two or more of a microcomputer, a processor, and a dedicated circuit. A specific aspect of controller 22 is not particularly limited.

Storage 23 is a storage device that stores a control program executed by controller 22. Storage 23 stores three-dimensional information about the new equipment and traffic line information about the new equipment. FIG. 3 is a diagram showing an example of traffic line information T according to the present exemplary embodiment.

As shown in FIG. 3, traffic line information T includes information indicating an equipment name, a movable portion, and a movable range.

The equipment name is information for determining new equipment to be newly installed. In the example of FIG. 3, the equipment name is an example indicating a name of a device, but is not limited thereto, and may be a model number of new equipment. The new equipment may be a stationary type device such as a hairpin bending device, may be a device that a part of the device is movable, or may be a device in which the device itself moves, such as an automated guided vehicle (AGV).

The movable portion is information for determining a portion that can be moved in the new equipment. In the example in FIG. 3, an example is shown in which a bending portion that is a portion of the new equipment (for example, a hairpin bending device) i.s a movable portion. The movable portion is “whole” means that the whole new equipment moves (moves).

The movable range is information relating to a movability, such as a movable amount and a movable direction of the movable portion. The movable range may be, for example, a value described in a catalog or the like (for example, the maximum movable amount), or a movable amount to be used when the movable amount to be used is determined.

Storage 23 may store information (for example, point cloud data or the like) acquired via acquisitor 21. Specifically, storage 23 may store point cloud data D shown in FIG. 2. Storage 23 is realized by, for example, a semiconductor memory or the like.

Output 24 outputs information for superimposing and displaying the third object on the virtual space to display device 30 based on the control of controller 22. Output 24 is, for example, a wireless communication module or a wireless communication circuit, and outputs the third object to display device 30 by wireless communication. The communication standard of the wireless communication is not particularly limited. The wireless communication is radio wave communication, but may be optical communication or the like.

In the above description, the example in which acquisitor 21 and output 24 are a wireless communication module or a wireless communication circuit has been described. However, the present exemplary embodiment is not limited thereto, and may be a wired communication module or a wired communication circuit. Acquisitor 21 may acquire point cloud data via a recording medium such as a universal serial bus (USB) memory. Output 24 may output information for superimposing and displaying the third object on the virtual space via a recording medium such as a USB memory.

Display device 30 displays information acquired from image generation device 20 as an image. The image includes a photograph, a moving image, an illustration, a character, or the like. The image output by display device 30 is visually recognized by an operator, and is used for checking whether or not there is interference. Display device 30 is realized by a liquid crystal display or the like. Display device 30 may be a display connected to a personal computer, a display included in a mobile device such as a smartphone or a tablet, or a display included in VR, goggles or the like.

Display device 30 is an example of an output device that outputs information acquired from image generation device 20. Display system 1 may include, as an output device, a device that displays information on a target (for example, a screen) such as a sound output device (for example, a speaker), a projector, or the like, and a device that outputs information using light (for example, light color) such as a light-emitting device, in place of display device 30 or together with display device 30.

### 2. Operation of Display System

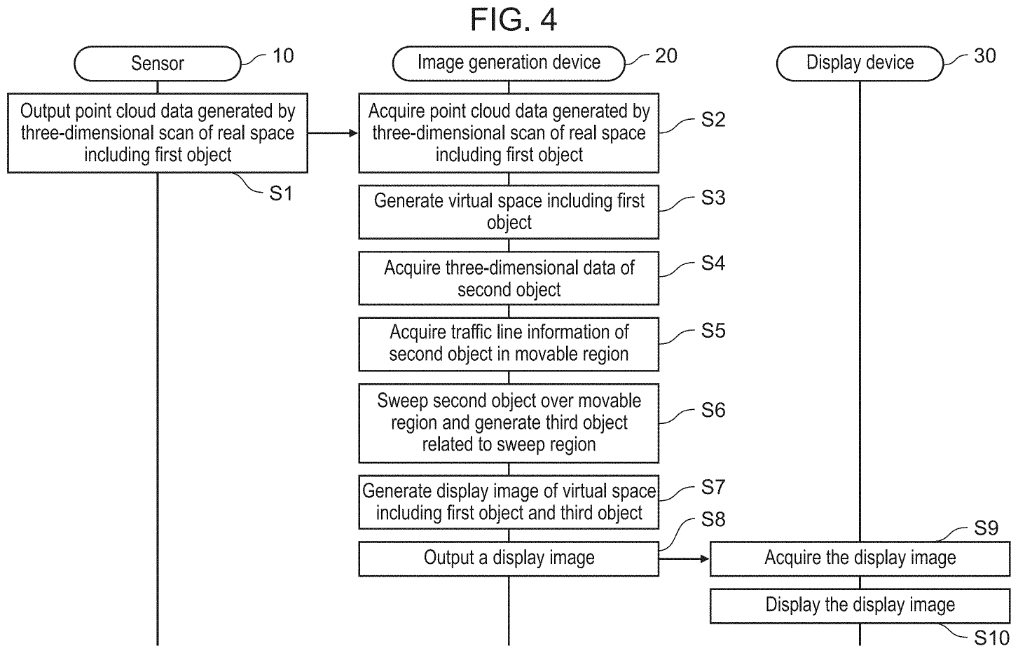

Next, the operation of display system 1 as described above will be described with reference to FIGS. 4 to 8. FIG. 4 is a sequence diagram showing an operation of display system 1 according to the present exemplary embodiment.

As shown in FIG. 4, sensor 10 outputs point cloud data D (see FIG. 2) generated by a three-dimensional scan of the real space including the first object (existing equipment) to image generation device 20 (S1). Sensor 10 outputs point cloud data D at each of the plurality of measurement portions to image generation device 20.

Image generation device 20 acquires the point cloud data generated by the three-dimensional scan of the real space including the first object (S2). Specifically, acquisitor 21 acquires the point cloud data output from sensor 10. Controller 22 generates a virtual space including the first object based on the point cloud data measured at the plurality of portions (S3). The method by which controller 22 generates one virtual space from the point cloud data measured at the plurality of portions is not particularly limited, and a related art may be used. Therefore, the description of the method of generating a virtual space will be simplified.

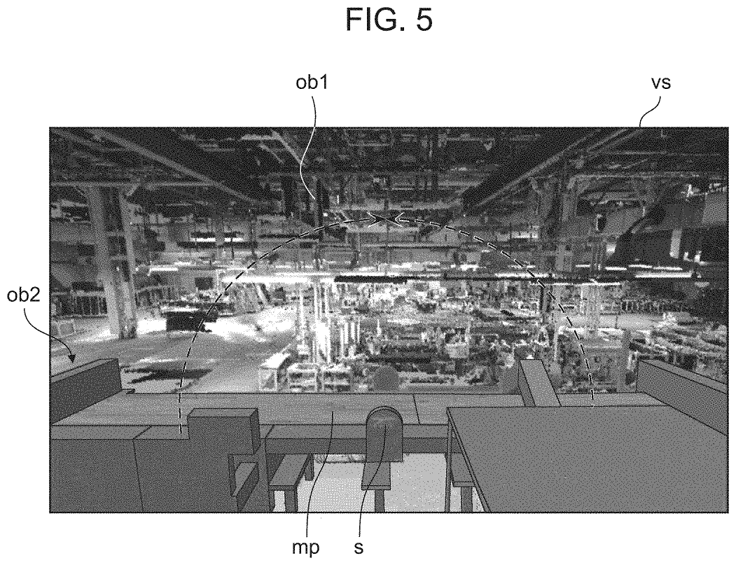

Controller 22 converts, for example, position data of a plurality of point cloud data measured at each of the plurality of portions into position data in the same three-dimensional space. Controller 22 generates one virtual space by disposing the plurality of point cloud data in an absolute coordinate space based on, for example, the coordinates (for example, surveying coordinates) of a marker position inside the factory. At each of the plurality of portions measured by sensor 10, at least one marker position is provided within a measurement range at the portion where the measurement is performed. FIG. 5 is a diagram in which second object ob2 is superimposed on virtual space vs according to the present exemplary embodiment. FIG. 5 shows an image of virtual space vs viewed from a certain viewpoint.

As shown in FIG. 5, controller 22 generates virtual space vs including first object ob1 based on the point cloud data acquired via acquisitor 21. FIG. 5 illustrates second object ob2, but in step S3, virtual space vs excluding second object ob2 is generated. Controller 22 may store generated virtual space vs in storage 23.

Next, controller 22 acquires three-dimensional data of second object ob2 (S4). Controller 22 may acquire the three-dimensional data of second object ob2 by reading the three-dimensional data of second object ob2 stored in storage 23, for example. For example, controller 22 superimposes second object ob2 on virtual space vs. FIG. 5 shows an image in which second object ob2 is superimposed on virtual space vs. Hereinafter, an example in which the three-dimensional data is solid data will be described.

As shown in FIG. 5, second object ob2 is superimposed on virtual space vs. In other words, second object ob2 is disposed in the three-dimensional space formed of the point cloud data. In the image shown in FIG. 5, first object ob1 and second object ob2 do not interfere with each other. However, in the image shown in FIG. 5, the movable region of movable portion mp included in second object ob2 is not displayed. That is, in the image shown in FIG. 5, when second object ob2 is movable, it cannot be determined whether or not first object ob1 and second object ob2 interfere with each other.

Referring again to FIG. 4, thereupon, controller 22 performs processing (S5 to S8) for superimposing and displaying data indicating the movable region of movable portion mp of second object ob2 on virtual space vs. Specifically, controller 22 acquires traffic line information T of second object ob2 (S5). Controller 22 may acquire traffic line information T corresponding to second object ob2, for example, by reading traffic line information T stored in storage 23. The dashed line arrows shown in FIG. 5 indicate the trajectory of movable portion (bending portion) mp when it is movable. The trajectory is based on traffic line information T.

Next, controller 22 sweeps second object ob2 over the movable region on the virtual space, and specifies a sweep region on the virtual space. Thereafter, third object ob3 related to the specified sweep region is generated (S6). The sweep region is a region indicating a movable region (movable range) of second object ob2 on the virtual space. Third object ob3 is an object corresponding to the movable region of movable portion mp of second object ob2. Thereby, the movable region can be modeled without actually moving the new equipment. Third object ob3 is formed of solid data when second object ob2 is formed of solid data for example.

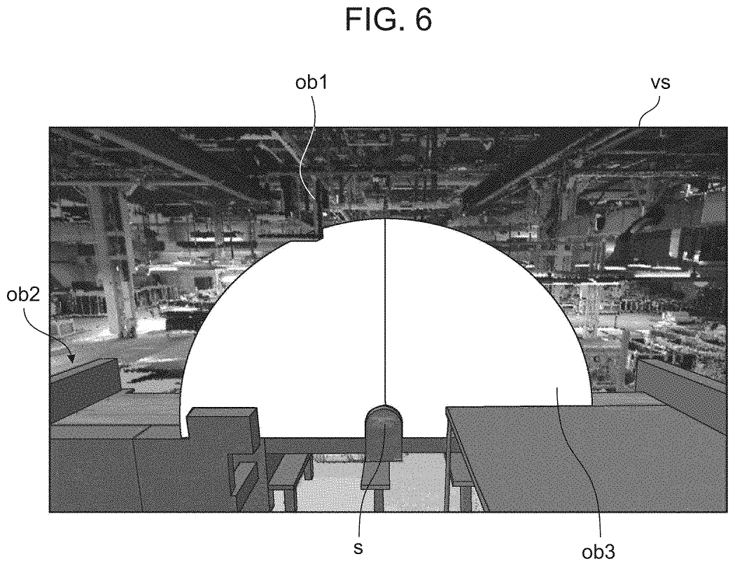

Next, controller 22 generates a display image of virtual space vs including first object ob1 and third object ob3 (S7). Specifically, controller 22 generates a display image that is an image of a virtual space, which is obtained by superimposing third object ob3 on virtual space vs including first object ob1, viewed from a certain viewpoint. FIG. 6 is a diagram in which third object ob3 is superimposed on virtual space vs shown in FIG. 5. The certain viewpoint is, for example, a viewpoint capable of verifying interference between first object ob1 and third object ob3.

As shown in FIG. 6, controller 22 superimposes third object ob3 corresponding to the movable region of movable portion mp on a position of movable portion mp of second object ob2.

Referring again to FIG. 4, next, controller 22 outputs the generated display image to display device 30 via output 24 (S8). Controller 22 outputs, for example, the image shown in FIG. 6 to display device 30 as a display image. The display image is an example of an image.

Next, display device 30 acquires the display image output from image generation device 20 (So), and displays the acquired display image (S10). By checking the display image displayed on display device 30, the operator can determine whether or not first object ob1 and third object ob3 are interfering with each other. Since the color information is included in the point cloud data forming first object ob1, the operator can determine whether or not first object obi and third object ob3 are interfering with each other based on the display image that is close to the actual situation inside the factory

In step S4, an example has been described in which second object ob2 is formed of the solid data, and third object ob3 is also formed of the solid data. However, the present exemplary embodiment is not limited to this. For example, second object ob2 may be formed of surface data, and third object ob3 obtained by sweeping second object ob2 may be also formed of the surface data. Second object ob2 may be formed of polygon data, and third object ob3 obtained by sweeping second object ob2 may be also formed of the polygon data. Second object ob2 may be formed of the point cloud data, and third object ob3 obtained by sweeping second object ob2 may be also formed of the point cloud data.

Third object ob3 may be formed of surface data obtained by sweeping second object ob2, or data formed based on the point cloud data. For example, third object ob3 may be formed of surface data obtained by sweeping second object ob2 or solid data obtained by converting the point cloud data.

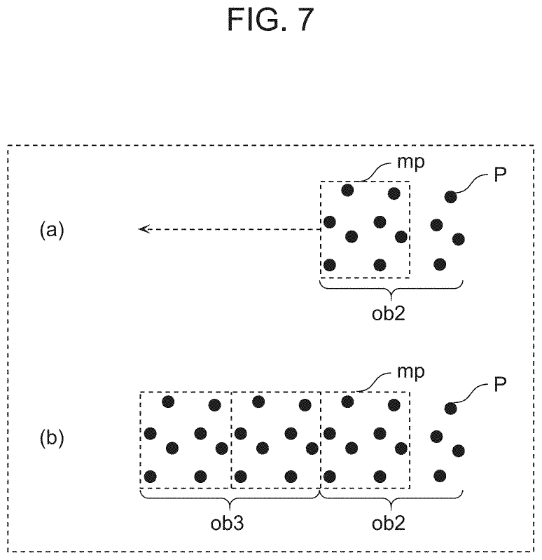

As an example, a method of sweeping the point cloud data will be described with reference to FIG. 7. FIG. 7 is a diagram showing an example of sweeping of the point cloud data. Specifically, it is assumed that it shows a part of the movable portion of second object ob2.

As shown in the upper part (a) of FIG. 7, first, a point cloud that is a target to sweep is selected from a plurality of points p (point cloud based on point cloud data) forming second object ob2. The upper part (a) of FIG. 7 shows an example in which a point cloud within the dashed line frame is a point cloud that is a target to sweep. That is, the point cloud in the dashed line frame in the upper part (a) of FIG. 7 is a point cloud forming movable portion mp.

The dashed line arrow shown in the upper part (a) of FIG. 7 indicates the traffic line information of the movable portion, the direction of the dashed line arrow indicates the movable direction, and the length of the dashed line arrow indicates the movable amount.

The lower part (b) of FIG. 7 is a diagram in which the point cloud selected in the upper part (a) of FIG. 7 is swept. For example, the point cloud is swept by copying the selected point cloud along the dashed line arrow at a predetermined interval. The copied point cloud is an example of third object ob3.

Even when second object ob2 is the surface data or the polygon data, second object ob2 can be swept by the same method.

When third object ob3 is formed of surface data, polygon data, or point cloud data, controller 22 may generate a display image such that first object ob1 and third object ob3 are displayed in different colors from each other. Accordingly, the operator can determine whether or not first object ob1 and third object ob3 are interfering with each other based on the difference in color, and thus can more easily determine whether or not there is interference. For example, when both first object ob1 and third object ob3 are generated based on the point cloud data, by displaying first object ob1 and third object ob3 in different colors from each other, the operator can easily determine particularly whether or not there is interference.

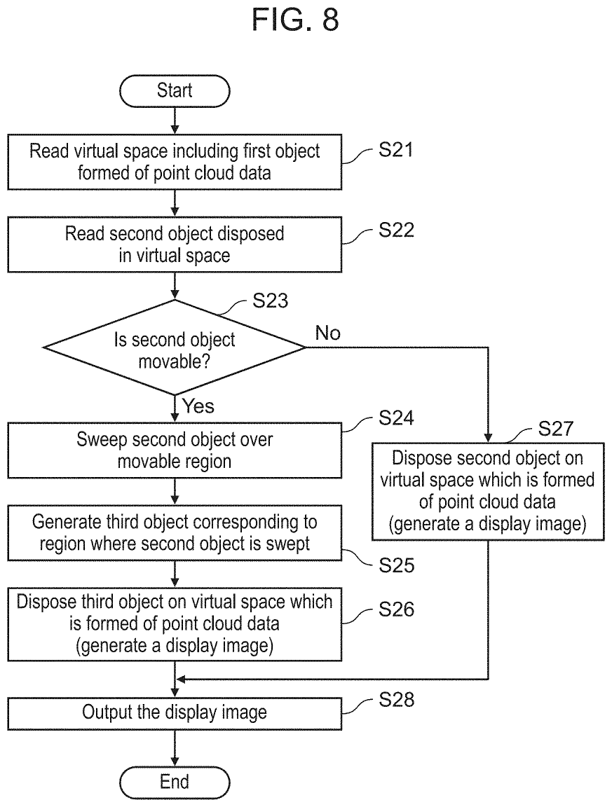

Next, the operation of image generation device 20 will be described with reference to FIG. 8. FIG. 8 is a flowchart showing an operation of image generation device 20 according to the present exemplary embodiment. The series of operations shown in FIG. 8 is an example of a display method.

As shown in FIG. 8, controller 22 reads virtual space vs including first object ob1 formed of the point cloud data (S21). Controller 22 reads, for example, virtual space vs including first object ob1 which is generated based on the point cloud data in step S3 and stored in storage 23 from storage 23.

Next, controller 22 reads second object ob2 disposed in virtual space vs (S22). Controller 22 reads, for example, second object ob2 stored in storage 23 in advance from storage 23, and dispose second object ob2 on, for example, virtual space vs. Step S22 corresponds to step S4 shown in FIG. 4.

Next, controller 22 determines whether or not second object ob2 is movable (S23). That is, controller 22 determines whether or not second object ob2 has a movable portion. Controller 22 determines whether second object ob2 is possible based on, for example, information indicated by the “movable portion” included in traffic line information T stored in storage 23. For example, when storage 23 stores the catalog information of second object ob2 (catalog information of the new equipment), controller 22 may make a determination in step S23 based on the catalog information.

Next, when it is determined that second object ob2 is movable (Yes in S23), controller 22 specifies the sweep region by sweeping second object ob2 over the movable region on the virtual space (S24). Third object ob1 corresponding to the sweep region where second object ob2 is swept is generated (S25). Specifically, controller 22 sweeps movable portion mp of second object ob2 on the virtual space based on the information indicated by the “movable range” included in traffic line information T, and specifies a sweep region. Thereafter, third object ob3 corresponding to the sweep region of movable portion mp is generated. Steps S24 and S25 correspond to step S6 shown in FIG. 4.

Next, controller 22 disposes third object ob3 on virtual space vs which is formed of the point cloud data (S26). Thereby, a display image (for example, the image shown in FIG. 6) of virtual space vs including first object ob 1 and third object ob3 is generated. Step S26 corresponds to step S7 shown in FIG. 4. The display image generated in step S26 may include second object ob2.

When it is determined that second object ob2 is not movable (No in S23), controller 22 disposes second object ob2 on virtual space vs which is formed of the point cloud data (S27). Controller 22 disposes second object ob2 on virtual space vs without sweeping second object ob2. Thereby, a display image (for example, the image shown in FIG. 5) of virtual space vs including first object ob1 and second object ob2 is generated.

Next, controller 22 outputs the display image generated in step S26 or S27 to display device 30 (S28). The image output in step S28 executed after step S26 is an example of information for superimposing and displaying third object ob3 on virtual space vs.

By checking the display image displayed on display device 30, the operator can determine whether or not first object ob1 and third object ob3 are interfering with each other. The operator can, for example, examine the installation position of the new equipment based on the display image displayed on display device 30.

By image generation device 20 executing the above-described process, even in simulation software having no interference check function of a movable object (new equipment in the present exemplary embodiment) such as a three-dimensional CAD, for example, a simulation in which the movement of the movable object is considered can be performed. When first object ob1 is handled as the point cloud data as it is, the processing amount can be reduced as compared with the case where first object is formed of the solid data or the like, the processing amount in image generation device 20 for generating an image can be reduced. That is, according to the above-described display method, it is possible to improve the image generation speed.

A series of operations from step S21 to S26 shown in FIG. 8 is an operation for generating a display image, and can be said to be an image generation method.

As described above, the display method according to the present exemplary embodiment is a method for disposing second object ob2 on virtual space vs (an example of the first virtual space) including first object ob1 formed of point cloud data D acquired from the real space and displaying an image of the obtained virtual space vs (an example of the second virtual space) viewed from a certain viewpoint, the method including: sweeping second object ob2 over the movable region of second object ob2 on the virtual space to determine a sweep region; generating third object ob3 corresponding to a region where second object ob2 is swept; disposing third object ob3 on virtual space vs (an example of the third virtual space) in which second object ob2 is disposed; and outputting information for displaying the image of the obtained virtual space vs (an example of the third virtual space) viewed from the certain viewpoint.

As described above, image generation device 20 according to the present exemplary embodiment is image generation device 20 configured to dispose second object ob2 on virtual space vs (an example of the first virtual space) including first object ob1 formed of point cloud data D acquired from the real space and generate an image of the obtained virtual space vs (an example of the second virtual space) viewed from a certain viewpoint, the device including controller 22 (an example of a circuit); and storage 23 (an example of a memory). Controller 22 specifies the sweep region by sweeping second object ob2 over the movable region of second object, ob2 using storage 23, generates third object ob3 corresponding to the region where second object ob2 is swept, disposes third object ob3 on virtual space vs. (an example of the second virtual space) in which second object ob2 is disposed, and outputs an image of obtained virtual space vs (third virtual space) viewed from a certain viewpoint.

The image of the second virtual space viewed from a certain viewpoint is, for example, the image shown in FIG. 5. The image of the third virtual space viewed from a certain viewpoint is, for example, the image shown in FIG. 6.

### 3. Effects

As described above, the display method according to the present exemplary embodiment is a display method for superimposing and displaying second object ob2 on virtual space vs including first object ob1 which is formed of point cloud data D acquired from the real space, the method includes determining the sweep region by sweeping second object ob2 over the movable region of second object ob2 (S24); generating third object ob3 corresponding to the region in which second object ob2 is swept (S25), and outputting the information for superimposing and displaying third object ob3 on virtual space vs (S28).

The first object is, for example, an object corresponding to the existing equipment, and the second object is an object corresponding to the new equipment.

Thereby, it is possible to generate an image in which interference between the new equipment and the existing equipment (first object) can be checked without moving movable portion mp of the new equipment (second object), that is, without acquiring the time series data of the new equipment. The operator can check the interference between the new equipment and the existing equipment by looking at the image generated using the above method. Therefore, according to the image generation method of the present exemplary embodiment, a display for checking (verifying) whether or not interference occurs can be performed without moving the actual device. In other words, according to the image generation method, it is possible to generate an image for checking (verifying) whether or not interference occurs without moving the actual device.

Second object ob2 is an object generated based on point cloud data D.

Accordingly, even when there is no three-dimensional CAD data or the like in the second object, the above-described image can be generated using the point cloud data measured by the 3D scanner or the like.

Point cloud data D includes color data obtained by measuring a three-dimensional object existing in the real space.

Thereby, the generated image becomes an image close to the real space. Therefore, the operator can more easily determine whether or not first object ob1 and third object ob3 interfere with each other.

As described above, image generation device 20 according to the present exemplary embodiment is image generation device 20 configured to generate an image of the virtual space obtained by superimposing second object ob2 on virtual space vs including first object ob1 formed of point cloud data D acquired from the real space, the device includes controller 22 (an example of a circuit), and storage 23 (an example of a memory). Controller 22 specifies the sweep region by sweeping second object ob2 over the movable region of second object ob2 using storage 23, generates third object ob3 corresponding to the region where second object ob2 is swept, and outputs an image for superimposing and displaying third object ob3 on virtual, space vs. The program is a program for causing a computer to execute the above display method.

Thereby, the same effect as the above-described display method can be obtained. Specifically, it is possible to generate an image for checking whether or not interference occurs without moving the actual device.

### Modification Example of Exemplary Embodiment 1

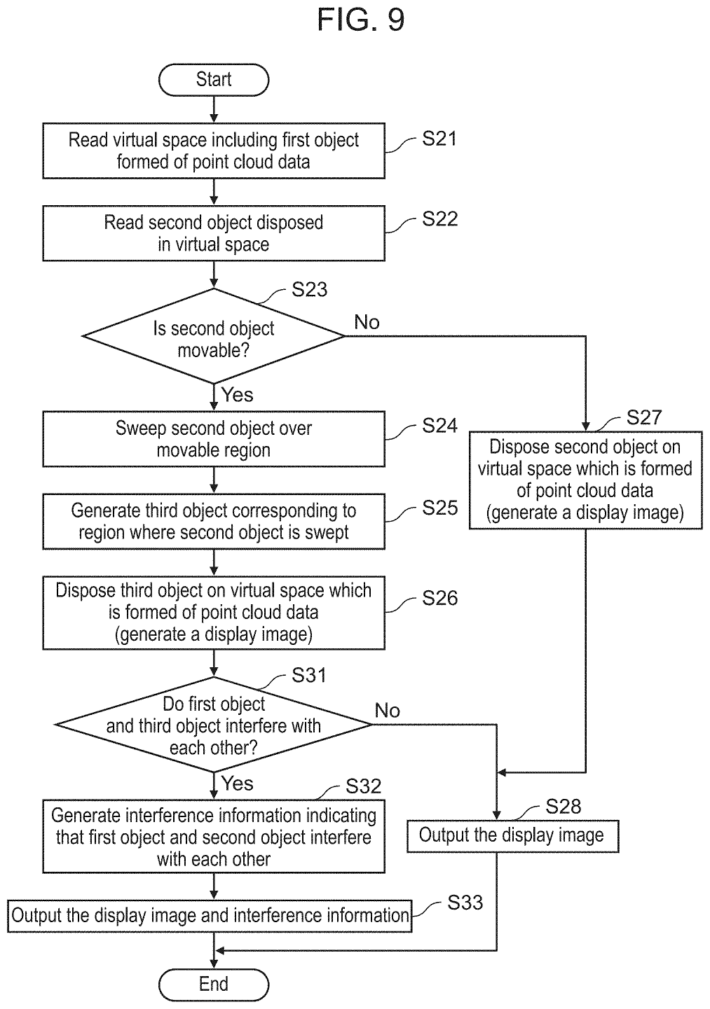

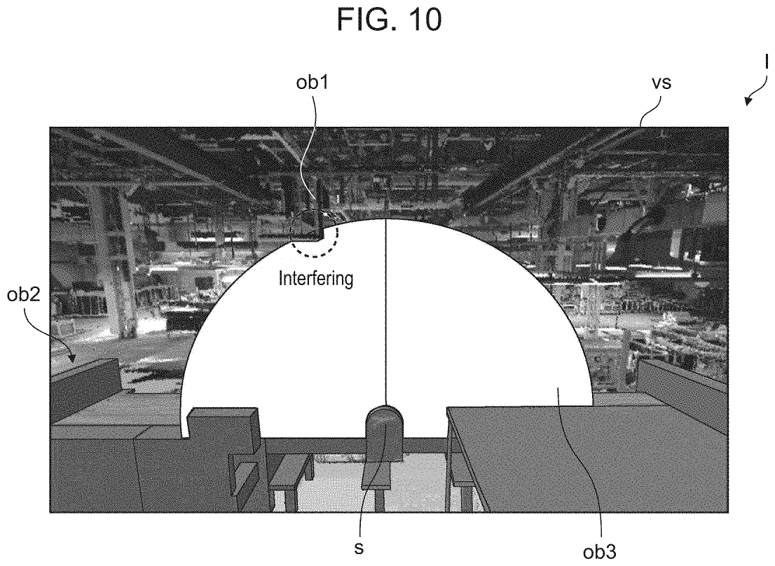

Next, a display system according to Modification Example 1 of Exemplary Embodiment 1 will be described with reference to FIGS. 9 and 10. The configurations of display system 1 and image generation device 20 according to the present modification example are the same as those of display system 1 and image generation device 20 according to Exemplary Embodiment 1, and a description thereof will not be repeated.

FIG. 9 is a flowchart showing the operation of image generation device 20 according to the present modification example. In the flowchart in FIG. 9, the same processes as those in the flowchart in FIG. 8 are denoted by the same reference numerals, and description thereof will be omitted or simplified. In the following, it is assumed that third object ob3 is formed of the solid data.

As shown in. FIG. 9, when third object ob3 is disposed on virtual space vs formed of the point cloud data (S26), controller 22 determines whether or not first object ob1 and third object ob3 interfere with each other (S31). For example, when at least one of the point cloud forming first object ob1 is in contact with third object ob3 or is positioned inside third object ob3, controller 22 determines that first object ob1 and third object ob3 interfere with each other.

Controller 22 may determine that first object ob1 and third object ob3 interfere with each other when, for example, first object ob1 and third object ob3 are equal to or shorter than a predetermined distance. The term “interference” includes a possibility of interference. The predetermined distance may be determined based on various intersections, or may be a predetermined value. The various intersections include, for example, the position accuracy of the point cloud data forming first object ob1, the dimensional tolerance of second object ob2, the movable region intersection of third object ob3, and the installation intersection of second object ob2.

When it is determined that first object ob1 and third object ob3 interfere with each other (Yes in S31), controller 22 generates interference information indicating that first object ob1 and second object ob2 interfere with each other (S32). The interference information is information for notifying the operator of the fact that first object ob1 and second object ob2 interfere with each other. In the present modification example, the interference information is information for indicating the interference with an image. The interference information may be information for indicating that interference occurs by sound when display system 1 includes a sound output device, or may be information for indicating that interference occurs by a light-emitting color when display system 1 includes a light-emitting device.

When it is determined that there is a possibility of interference in step S31, controller 22 may generate information indicating that there is a possibility of interference in step S32. The information indicating that there is a possibility of interference is, for example, information indicating that first object ob1 and third object ob3 approach each other, and is included in the interference information.

Next, controller 22 outputs the display image and the interference information to display device 30 via output 24 (S33). FIG. 10 is a diagram showing an example of display image I according to the present modification example.

As shown in FIG. 10, controller 22 may superimpose and display the interference information on display image I. Controller 22 may superimpose and display, for example, information indicating the position of interference (dashed line circle shown in FIG. 10) and information indicating interference (“interfering” in FIG. 10) on display image I.

When it is determined that first object ob1 and third object ob3 do not interfere with each. other (No in S31), controller 22 outputs the display image generated in step S26 to display device 30 via output 24 (S28). When ‘No’ is determined in step S31, controller 22 may generate non-interference information indicating that there is no interference, and output the non-interference information to display device 30 together with the display image.

As described above, third object ob3 is formed of the solid data, and the display method according to the present modification example further includes: determining whether or not first object ob1 and third object ob3 interfere with each other (S31); and when first object ob1 and third object ob3 interfere with each other (Yes in S31), outputting information indicating that first object ob1 and second object ob2 interfere with each other (S33).

Thereby, it is possible to cause a processing device such as image generation device 20 to determine whether or not first object ob1 and third object ob3 interfere with each other. The operator can easily know whether or not first object ob1 and third object ob3 interfere with each other by looking at the determination result of image generation device 20.

### Exemplary Embodiment 2

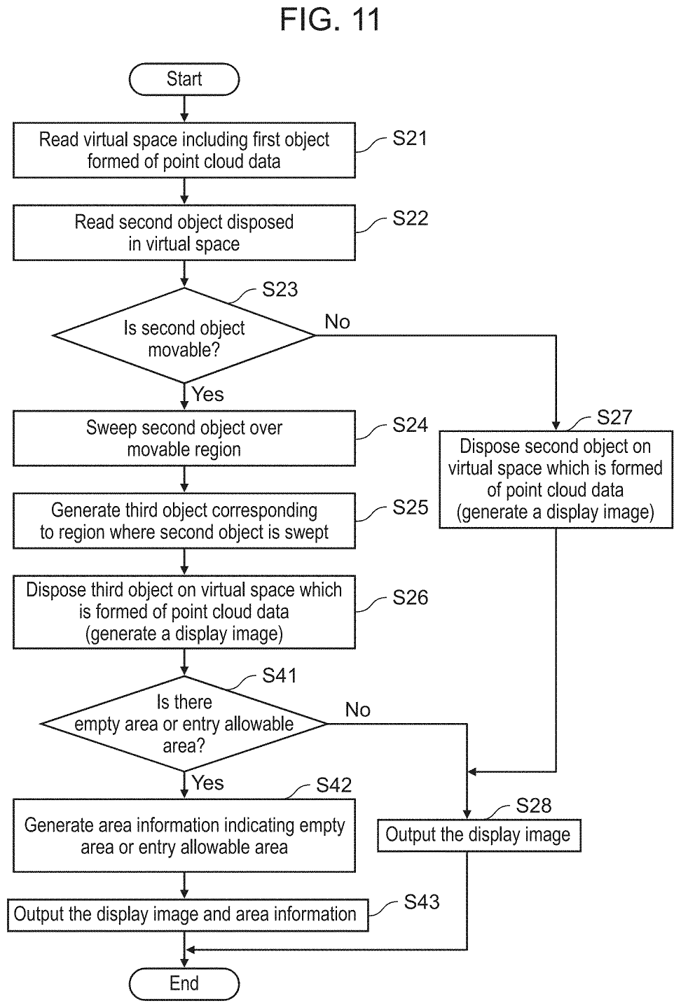

Next, a display system according to Exemplary Embodiment 2 will be described with reference to FIGS. 11 to 13. The configurations of display system 1 and image generation device 20 according to the present exemplary embodiment are the same as those of display system 1 and image generation device 20 according to Exemplary Embodiment 1, and a description thereof will not be repeated.

In the present exemplary embodiment, an example will be described in which the new equipment is a moving body (for example, an AGV) where the new equipment itself moves. Display system 1 is applied, for example, when an AGV is introduced or when the guide route of the AGV is changed.

FIG. 11 is a flowchart showing an operation of image generation device 20 according to the present exemplary embodiment. In the flowchart in FIG. 11, the same processes as those in the flowchart in FIG. 8 are denoted by the same reference numerals, and description thereof will be omitted or simplified.

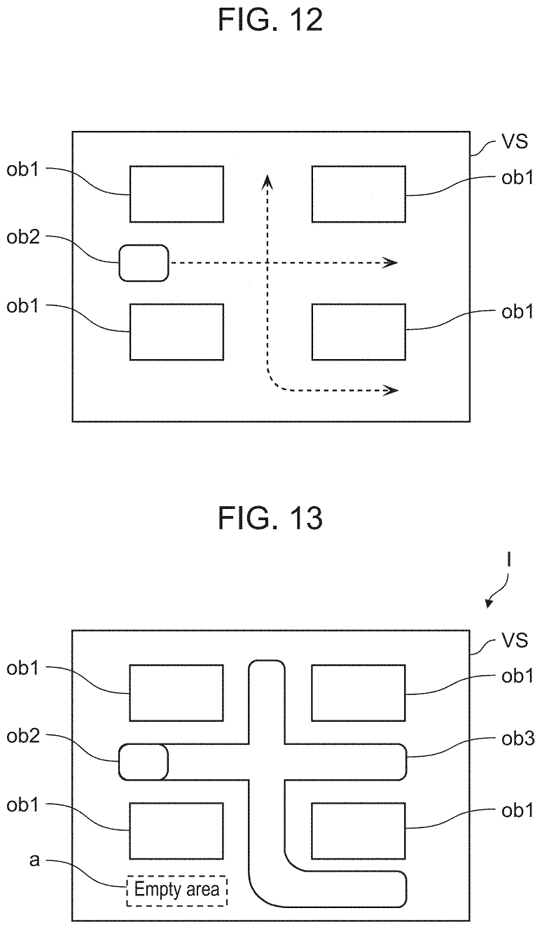

As shown in FIG. 11, controller 22 reads second object ob2 disposed in virtual space vs (S22). Controller 22 may dispose second object ob2 on virtual space vs. FIG. 12 is a diagram in which second object ob2 is superimposed on virtual space vs according to the present exemplary embodiment.

As shown in FIG. 12, second object ob2 is superimposed on virtual space vs including first object ob1 which is formed of the point cloud data. The image shown in FIG. 12 shows a position of each equipment inside the factory at a certain point in time. It is assumed that second object ob2 is, for example, an initial position (a position before movement). Second object ob2 is formed of any of solid data, surface data, polygon data, and point cloud data.

FIG. 12 shows an image of virtual space vs viewed from a certain viewpoint. In the present exemplary embodiment, a certain viewpoint is a viewpoint that views from above to below the factory. The dashed line arrow in FIG. 12 indicates the traffic line information of second object ob2, the direction of the dashed line arrow indicates the moving direction (movable direction), and the length of the dashed line arrow indicates the moving amount (movable amount).

Referring again to FIG. 11, next, when it is determined that second object ob2 is movable based on traffic line information T (Yes in S23), controller 22 sweeps second object ob2 over the movable region on the virtual space, and specifies the sweep region (S24). Controller 22 sweeps over the movable range (for example, a movable region specified by a program shown in FIG. 3) included in traffic line information T (see a dashed line arrow shown in FIG. 12). Controller 22 generates third object ob3 corresponding to the region where second object ob2 is swept (S25), and disposes generated third object ob3 on virtual space vs formed of the point cloud data (S26). That is, controller 22 generates a display image of virtual space vs including first object ob1 and third object ob3. FIG. 13 is a diagram showing an example of display image I according to the present exemplary embodiment. Specifically, FIG. 13 is an image of virtual space vs (an example of the third virtual space), which is obtained by superimposing third object ob3 on virtual space vs (an example of the second virtual space) shown in FIG. 12, viewed from above the factory.

As shown in FIG. 13, for example, controller 22 superimposes third object ob3 indicating a movable region of second object ob2 from the initial position.

Referring again to FIG. 11, next, when an empty area or an entry allowable area where an operator can enter is displayed based on point cloud data D (for example, display image I), controller 22 determines whether or not there is an empty area or an entry allowable area (S41). For example, controller 22 may determine that an area that does not overlap with any of first object ob1, second object ob2, and third object ob3 is an empty area or an entry allowable area. For example, controller 22 may determine that an area that is a predetermined distance or more away from any of first object ob1, second object ob2, and third object ob3 is an empty area or an entry allowable area.

The empty area is an area having a size equal to or greater than a predetermined size, for example, an area having a size equal to or greater than a size set by an operator in advance. The empty area may be, for example, an area for checking whether or not other equipment can be disposed. The entry allowable area is, for example, an area through which an operator can pass.

Next, when it is determined that there is an empty area or an entry allowable area (Yes in S41), controller 22 generates area information indicating the empty area or the entry allowable area (S42). The area information is information for notifying the operator of a position and a range of an empty area or an entry allowable area. In the present exemplary embodiment, the area information is information for indicating an entry allowable area with an image.

Next, controller 22 outputs display image I and the area information to display device 30 via output 24 (S43). As shown in FIG. 13, controller 22 may superimpose and display the area information on display image I. Area information a shown in FIG. 13 indicates an empty area.

When it is determined that there is no empty area or entry allowable area (No in S41), controller 22 outputs the display image generated in step S26 (for example, the image excluding area information a in FIG. 13) to display device 30 via output 24 (S28). When ‘No’ is determined in step S41, controller 22 may generate the area information indicating that there is no empty area or entry allowable area, and output the area information to display device 30 together with display image I.

In the present exemplary embodiment, as in the modification example of Exemplary Embodiment 1, controller 22 may determine whether or not first object ob1 and third object ob1 interfere with each other based on the display image generated in Step S26. When it is determined that first object ob1 and third object ob3 do not interfere with each other, controller 22 may execute the processing of step S41 and subsequent steps.

As described above, the display method according to the present exemplary embodiment further includes, when an empty area or an entry allowable area where an operator can enter is displayed based on point cloud data D in virtual space vs, outputting information for displaying a region excluding third object ob3 as an empty area or an area into which the operator can enter (S43).

Thereby, when there is an empty area or an entry allowable area, the operator can further know the area. By knowing the area, the operator can further examine the disposition of additional equipment or the human traffic line inside the factory.

### Other Exemplary Embodiment

As described above, each exemplary embodiment and modification example (hereinafter, also referred to as exemplary embodiment or the like) have been described, but the present disclosure is not limited to such exemplary embodiments or the like.

For example, in the modification example of Exemplary Embodiment 1, the example in which controller 22 generates the interference information indicating the interference when it is determined that first object ob1 and third object ob3 interfere with each other (Yes in S31 shown in FIG. 9), has been described, but is not limited thereto. For example, controller 22 may output, to display device 30, the information indicating how much the movable amount has caused the interference (for example, how many rotations of movable portion mp around fulcrum s cause interference), as interference information. Controller 22 may calculate the movable amount at the time of interference based on the initial position (position before movable) of movable portion mp and the position where the interference with first object ob1 occurred.

In Exemplary Embodiment 1, controller 22 may further determine whether or not there is an area in which an operator can enter based on first object ob1, second object ob2, and third object ob3 and output information indicating an entry allowable area to display device 30 together with the display image when there is the entry allowable area.

In the above-described exemplary embodiment or the like, the example in which controller 22 outputs an image, in which third object ob3 is superimposed on virtual space vs, on display device 30 has been described, but the present disclosure is not limited thereto. Controller 22 may output, for example, an image of virtual space vs including first object ob1 and an image including third object ob3 to display device 30 at different timings. In the images of virtual space vs acquired at different timings and third object ob3, display device 30 may superimpose third object ob3 on virtual space vs and display the superimposed image.

In the above-described exemplary embodiment or the like, the example in which controller 22 generates, as a display image, an image of virtual space vs including first object ob1 and third object ob3 viewed from one viewpoint has been described, but the present disclosure is not limited thereto. Controller 22 may generate two or more images of virtual space vs viewed from two or more different viewpoints as display images.

In the above-described exemplary embodiment or the like, the example in which first object ob1 (existing equipment) is a non-movable device or the like has been described, but first object ob1 may include a movable device. When first object ob1 is movable, controller 22 may further sweep first object ob1 over the movable region on the virtual space, generate a fourth object related to the sweep region, and generate a display image of the virtual space including the fourth object. That is, the display image may include first object obi, second object ob2, third object ob3, and the fourth object. The operator can verify whether or not there is interference by using first object ob1, the fourth object, and third object ob3. The fourth object is an object based on the point cloud data.

In the above-described exemplary embodiment or the like, an example in which the number of display devices 30 connected to image generation device 20 is one has been described, but two or more display devices 30 may be provided.

The division of the functional blocks in the block diagram shown in FIG. 1 is an example, and a plurality of functional blocks may be realized as one functional block, one functional block may be divided into a plurality of functional blocks, or some functions may be transferred to another functional block. The functions of a plurality of functional blocks having similar functions may be processed by a single piece of hardware or software in parallel or time division.

In the above-described exemplary embodiment or the like, image generation device 20 is realized by a single device, but may be realized by a plurality of devices connected to each other. In the above-described exemplary embodiment, an example has been described in which image generation device 20 and display device 30 are separate devices, but image generation device 20 may include display device 30.

The communication method between the devices included in display system 1 in the above-described exemplary embodiment or the like is not particularly limited. Wireless communication or wired communication may be performed between the devices.

The order in which each of the steps in the flowchart is executed is merely an example for specifically describing the present disclosure, and may be an order other than the above. For example, a part of the above steps may be executed simultaneously (in parallel) with other steps, or may be executed in a different order from the other steps.

A part or all of the components included in image generation device 20 in the above-described exemplary embodiment or the like may be configured with one system large scale integration (LSI). For example, image generation device 20 may be configured with a system LSI having a processor such as controller 22.

The system LSI is a super-multifunctional LSI manufactured by integrating a plurality of components on one chip, and specifically, a computer system including a microprocessor, a read only memory (ROM), a random access memory (RAM), and the like. The ROM stores a computer program. The microprocessor operates according to the computer program, and thus the system LSI achieves its function.

Although the system LSI is used here, it may also be called an IC, an LSI, a super LSI, or an ultra LSI depending on the difference of the degree of integration. The method of circuit integration is not limited to LSI, and may be realized by a dedicated circuit or a general-purpose processor. After the LSI is manufactured, a field programmable gate array (FPGA) that can be programmed, or a reconfigurable processor that can reconfigure the connection or setting of circuit cells inside the LSI may be used.

As long as an integrated circuit technology that replaces the LSI appears due to the progress of the semiconductor technology or another technology derived therefrom, the functional blocks may be naturally integrated using the technology. Application of biotechnology or the like is possible.

One aspect of the present disclosure may be a computer program that causes a computer to execute characteristic steps included in a display method. Another aspect of the present disclosure may be a non-transitory computer-readable recording medium on which such a computer program is recorded.

In the above exemplary embodiment or the like, each component may be configured with dedicated hardware, or may be realized by executing a software program suitable for each component. Each component may be realized by a program executor such as a CPU or a processor reading and executing a software program recorded on a recording medium such as a hard disk or a semiconductor memory.

The general or specific aspects of the present disclosure may be realized by a recording medium such as a system, a method, an integrated circuit, a computer program, or a computer-readable CD-ROM, or may be implemented by any combination of the system, the integrated circuit, the computer program, and the recording medium.

According to the display method and the like of one aspect of the present disclosure, a display for checking whether or not interference occurs can be performed without moving an actual device.

A form obtained by performing various modifications conceivable by those skilled in the art to the exemplary embodiment, or a form realized by combining any components and functions in each exemplary embodiment without departing from the spirit of the present disclosure is also included in the present disclosure.

What is claimed is:

1. A display method for superimposing and displaying a second object on a virtual space including a first object which is formed of first point cloud data acquired from a real space, the display method comprising:
determining a movable region of the second object;
generating a third object corresponding to the movable region; and
outputting information for superimposing and displaying the third object on the virtual space.

2. The display method of claim 1,
wherein the third object is formed of solid data, and
the display method further comprises:
determining whether or not the first object interferes with the third object; and
outputting information indicating that the first object and the second object interfere with each other when it is determined that the first object interferes with the third object.

3. The display method of claim 1,
wherein the second object is an object generated based on second point cloud data.

4. The display method of claim 1, further comprising:
when an empty area or an entry allowable area into which an operator can enter is displayed based on the first point cloud data in the virtual space, outputting information for displaying a region excluding the third object as the empty area or the entry allowable area.

5. The display method of claim 1,
wherein the first point cloud data includes color data obtained by measuring a three-dimensional object existing in the real space.

6. An image generation device for generating an image of a virtual space obtained by superimposing a second object on the virtual space including a first object which is formed of point cloud data acquired from a real space, the image generation device comprising:
a circuit; and
a memory,
wherein the circuit is configured to, by using the memory,
determine a movable region of the second object,
generate a third object corresponding to the movable region, and
output the image for superimposing and displaying the third object on the virtual space.

7. A non-transitory computer-readable recording medium on which a program for causing a computer to execute the display method of claim 1 is recorded.
